(19) United States
(12) Patent Application Publication
(10) Pub. No.: US 2016/0032649 A1
(43) Pub. Date: Feb. 4, 2016

(54) Telescopic Ladder Comprising Ladder Sections Of Different Densities

(71) Applicant: GIMAEX INTERNATIONAL, Saint Maur Des Fosses (FR)

(72) Inventor: Gilles Moreau, Sevrier (FR)

(73) Assignee: GIMAEX INTERNATIONAL, Saint Maur Des Fosses (FR)

(21) Appl. No.: 14/810,834

(22) Filed: Jul. 28, 2015

(30) Foreign Application Priority Data
Jul. 29, 2014 (FR) 1457321

(51) Int. Cl. E06C 5/04; E06C 7/18

(52) U.S. Cl. CPC E06C 5/04; E06C 7/183

(57) ABSTRACT

A telescopic ladder includes a proximal end adapted to be fixed on a support, the ladder including between the proximal end and a distal end a plurality of sections displaceable relative to each other for deploying the ladder, the section arranged at the level of the proximal end of the ladder being made of material having a density greater than the density of the material of which at least one other section of the ladder is made.

### CROSS-REFERENCE TO RELATED APPLICATIONS

This application claims the benefit and priority of French Patent Application No. 14 57 321, filed Jul. 29, 2014. The entire disclosure of the above application is incorporated herein by reference.

### BACKGROUND AND SUMMARY

The present invention relates to a telescopic ladder comprising ladder sections made of materials of different densities. The invention also relates to a vehicle on which such a telescopic ladder is fixed.

Telescopic ladder means a ladder composed of several sections displaceable relative to each other so as to vary the total length of the ladder via displacement of the sections relative to each other. A known type of telescopic ladder is a ladder extending between a proximal end fixed on a vehicle and a distal end opposite the proximal end, the distal and proximal character of the ends being defined relative to the vehicle. The distal end is moved away from the proximal end by sliding the sections relative to each other so as to arrange them substantially end to end and retain a covering portion between the sections. The ladder can generally be moved in rotation along several axes so as to further vary the position of the distal end of the ladder. This type of telescopic ladder is used for undertaking tasks located at considerable heights or depths, especially for rescue of people in a fire protection vehicle. In this known type of telescopic ladder all the sections of the ladder are made of the same material, especially steel or aluminum.

Also, a particular need of this type of telescopic ladder is to be able to carry out tasks at minimal heights and depths but at a distance very far from the vehicle. In other terms, the maximal distance separating the proximal and distal ends, projected on a horizontal axis, must be the greatest possible. This distance is more generally called the maximal reach of the telescopic ladder. However, the maximal reach of this known type of telescopic ladder is not satisfactory and therefore does not carry out tasks at lesser heights and depths at a distance very far from the vehicle. There is therefore a need for a telescopic ladder having an augmented maximal reach.

For this purpose, the present invention proposes a telescopic ladder comprising a proximal end adapted to be fixed on a support, the ladder comprising between the proximal end and a distal end a plurality of sections displaceable relative to each other for deploying the ladder, the section arranged at the level of the proximal end of the ladder being made of material having a density greater than the density of the material of which at least one other section of the ladder is made. According to preferred embodiments, the invention comprises one or more of the following characteristics:

the at least one section other than the section arranged at the level of the proximal end is realise, fully or partly, in un material whereof the density is less than 5, preferably less than 3, preferably less than 2;

the at least one section other than the section arranged at the level of the proximal end is made, fully or partly, of material comprising carbon fibres;

the at least one section other than the section arranged at the level of the proximal end comprises two beams, at least one rung capable of being fixed between the beams, the rung extending in an extension direction and having at the level of a central portion of the rung a predetermined section perpendicular to the extension direction, the rung comprising a fixing surface of the rung to one of the beams, the surface area of the fixing surface being greater than the surface area of the predetermined section;

the beams each comprise a lateral surface capable of receiving the fixing surface of the rung, the lateral surface of at least one beam being inclined relative to a plane perpendicular to the extension direction of the rung;

the at least one section other than the section arranged at the level of the proximal end comprises a plurality of rungs capable of being fixed and extending between the beams each in an extension direction, in which the lateral fixing surface of at least one beam is inclined relative to a plane perpendicular to the extension direction of each of the rungs:

the two beams of the section comprise a lateral surface inclined relative to a plane perpendicular to the extension direction of at least one rung, preferably of each of the rungs;

at least one rung comprises an end of flared shape;

the at least one section other than the section arranged at the level of the proximal end also comprises two handrails each extending along one of the two beams, a plurality of support arms of the handrails capable of being fixed between a beam and a handrail extending along this beam, in which each support arm is formed jointly with another support arms integrally;

two support arms formed jointly integrally form a handrail support comprising a base capable of being put in contact and fixed on an upper surface of a beam, the base comprising an inclined portion capable of extending beyond the upper surface of the beam to allow the base to also be fixed on the lateral surface of this beam;

when the base of the handrail support is put in contact with the upper surface of a beam and a rung is arranged on the lateral surface of the beam facing the handrail support, the inclined portion of the handrail support is capable of covering a fixing portion of the rung;

the inclined portion, the fixing portion of the rung covered by the inclined portion and the lateral surface of the beam are fixed together, preferably by riveting;

the rung(s) and, where needed, the handrail support are fixed together or to the beam by adhesion and/or riveting;

the distal end of the ladder is defined when the ladder is fully deployed, the at least one section other than the section arranged at the level of the proximal end being that of the sections arranged at the level of the distal end of the ladder;

the ladder is a ladder for a fire protection vehicle and/or personal rescue vehicle, the proximal end of the ladder being capable of being fixed to the vehicle and the distal end being capable of being fixed to a suspended nacelle.

The present invention also relates to a vehicle comprising such a telescopic ladder. Other characteristics and advantages of the invention will emerge from the following description of a preferred embodiment of the invention, given by way of example and in reference to the appended drawings.

### BRIEF DESCRIPTION OF THE DRAWINGS

FIG. 1 illustrates a drawing of a vehicle supporting a telescopic ladder in fully deployed position.

FIG. 2 illustrates a drawing of a section of the telescopic ladder located at the level of a distal end of the telescopic ladder.

FIG. 3 illustrates a drawing of the attachment between a beam and a rung of this same section.

FIG. 4 illustrates a drawing of the attachment between a beam, a rung, a handrail support and a handrail of this same preceding section.

FIG. 5 illustrates a drawing of the attachment between this preceding section and an interface piece between the telescopic ladder and a suspended nacelle, the interface piece being shown in partial section.

### DETAILED DESCRIPTION

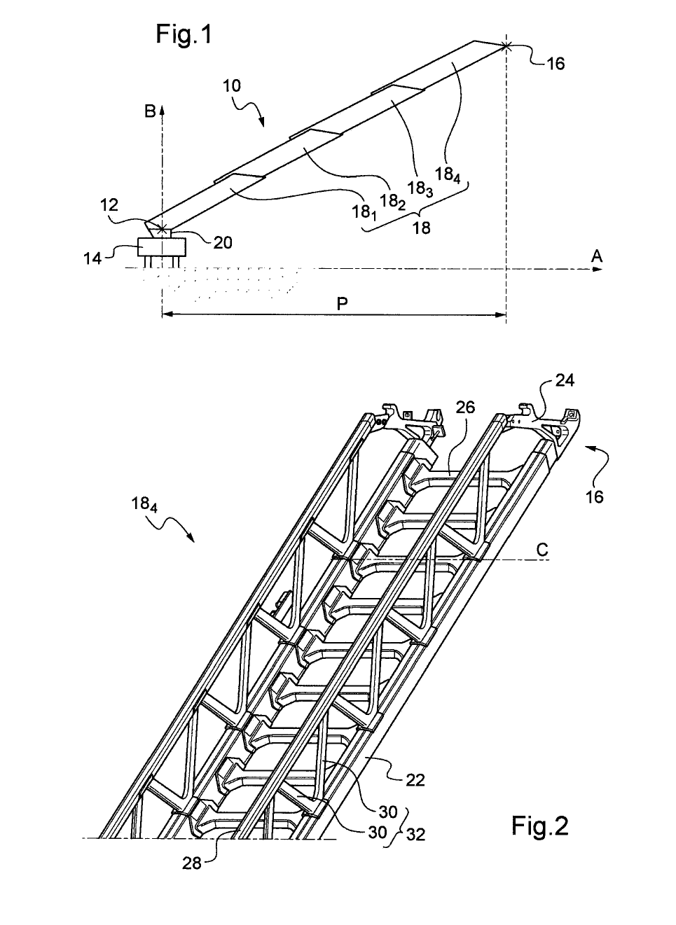

In reference to FIG. 1, a telescopic ladder 10 fixed to a support at the level of a proximal end 12 of the support is proposed. The support can be a vehicle, for example of fire protection type and/or personal rescue vehicle, or else a trailer to be hitched to a vehicle or even more generally any means for supporting and/or transporting the ladder 10. In this respect, a vehicle 14 is also proposed on which is arranged the telescopic ladder 10 described hereinbelow.

The ladder 10 comprises between the proximal end 12 and a distal end 16 a first, a second, a third and fourth sections 18₁, 18₂, 18₃ and 18₄. The proximal and distal character of the ends of the ladder 10 is defined relative to the vehicle 14. The number of sections is not limited to four. In fact, the ladder 10 can comprise a number of sections 18 greater than or equal to two. The sections 18 are displaceable relative to each other for deploying or reploying the ladder 10. In particular, the sections slide into each other such that the ladder 10 can be arranged from a fully reployed position, in which the sections 18 are arranged in each other, to a fully deployed position (position shown in FIG. 1), in which the sections 18 are substantially arranged end to end. More particularly, in the fully deployed position the sections overlap one by one such that a covering portion is formed between each of the sections. It should be noted that the distal end 16 of the ladder 10 corresponds to the end of the ladder 10 opposite the proximal end 12 when the ladder 10 is in the fully deployed position. In other terms, the distal end 16 of the ladder 10 is combined with the end of the fourth section 18₄, the farthest from the proximal end 12.

Also, the vehicle 14 comprises a turret 20 for setting the ladder 10 in rotation around a vertical axis B relative to the vehicle 14 and jacks (not shown) for inclining the ladder 10 around an axis perpendicular to the vertical axis B and to a horizontal axis A. The reach P of the ladder 10 is defined as being the distance, projected on the horizontal axis A, separating the proximal and distal ends 12 and 16.

For the ladder 10 to have a maximal reach P greater than a telescopic ladder having sections made of material of the same density, the section arranged at the level of the proximal end 12 of the ladder 10—that is, the first section 18₁—is made of material having a density greater than the density of the material of which at least one other section 18 of the ladder 10 is made. In other terms, the second, third and/or fourth sections 18₂, 18₃ and 18₄ are made, fully or partly, of material having a density less than the material used for making the first section 18₁ such that on the one hand the mass of the ladder 10 is decreased and on the other hand the centre of gravity of the ladder 10 is closer to the proximal end 12 relative to a ladder in which the second, third and fourth sections 18₂, 18₃ and 18₄ are made of material having the same density as the material used for the first section 18₁. The expressions “fully” and “partly” are detailed later. The combination of the decrease in the mass of the ladder 10 and the rapprochement of the centre of gravity to the proximal end 12, while ensuring the physical integrity of the ladder 10, decreases the minimal inclination of the ladder 10 such that the maximal reach P of the ladder 10 is increased. In particular, the inclination of the ladder 10 is defined as the angle formed between the ladder 10 and the horizontal axis A, in the plane formed by the horizontal and vertical axes A and B. In fact, the ladder 10 can be also arranged such that the distal end 16 is arranged at a lower altitude than ground level, or more generally at an altitude less than the altitude where the vehicle 14 is. The above advantages also apply to this latter case.

The materials used to make the sections 18 are for example, by decreasing order of density, steel, titanium, aluminum, composite materials based on fibre glass or else composite materials based on carbon fibre. So, when the first section 18₁ is made of steel, at least one of the other sections 18 is made for example of aluminum, titanium or composite materials of fibre glass or carbon. To further improve the maximal reach P of the ladder 10, the material whereof the density is less than the material used for the first section 18₁ is material whereof the density is less than 5, preferably 3, preferably 2. The density—called relative density—is defined as being the ratio between the volumic mass of this material and the volumic mass of water at 4° C., at atmospheric pressure.

To obtain a better ratio between the mechanical resistance of the ladder 10 and the rapprochement of the centre of gravity of the ladder towards the proximal end 12, the material used for the fourth section 18₄ is material based on carbon fibre, preferably at least partly based on carbon fibre known as “high modulus”, that is, carbon fibres having Young's modulus greater than 400 GPa. In this case, the material used for the first, second and third sections 18₁, 18₂ and 18₃ is steel or aluminum such that the manufacturing cost of the ladder 10 is limited. Also, the composite material based on carbon fibres used for the beams 22 can comprise supplementary folds of carbon fibres oriented in different directions and forming localised surplus thicknesses to enable the beams 22 to resist stresses exerted in different directions.

To allow satisfactory fixing of the pieces to each other when the material used for the at least one of the second, third and fourth sections 18₂, 18₃ and 18₄ is a composite material, especially based on carbon fibres, the pieces are fixed together by adhesion. To further increase the rigidity and reinforce attachment between the pieces, rivets are also used in combination with adhesion. To boost the maximal reach P of the ladder 10 and limit manufacturing costs of the ladder 10, only the section arranged at the level of the distal end 16—the fourth section 18₄—is made of material based on carbon fibre. In this case, the maximal reach P can be increased in height by 10% relative to a known type of telescopic ladder entirely made of steel.

In reference to FIG. 2, the fourth section 18₄ comprises two beams 22 extending parallel relative to each other as far as the distal end 16 of the ladder 10. The fourth section 18₄ also comprises between the two beams 22 a plurality of rungs 26 allowing a user to advance along the fourth section 18₄. The rungs 26 extend substantially parallel relative to each other, each following an extension direction C substantially perpendicular to the extension direction of the beams 22.

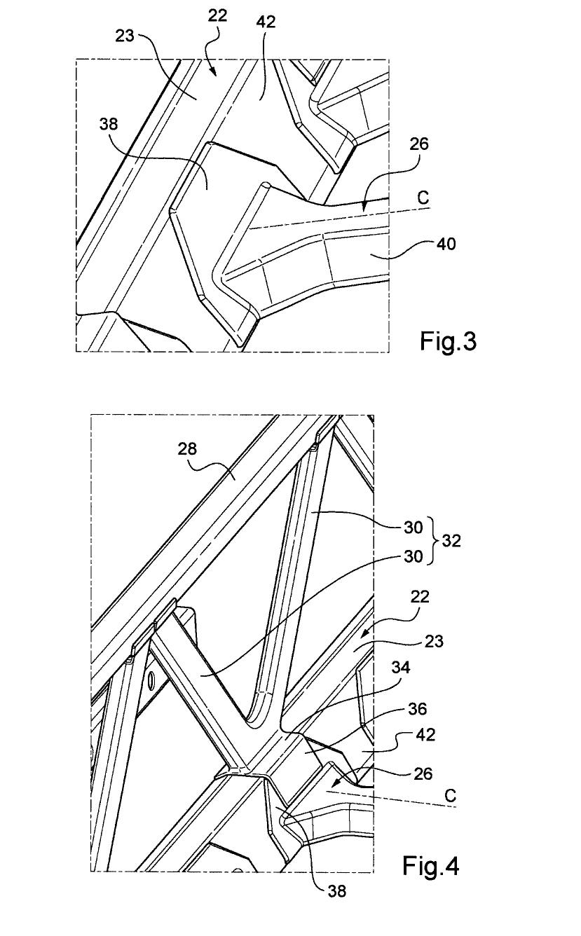

In reference to FIG. 3, the rungs 26 comprise at each of their ends a fixing portion 38 of the rung 26 to a beam 22. This fixing portion 38 comprises a fixing surface of the rung 26 (not shown) intended to be put in contact and fixed on a lateral surface 42 of a beam 22. Each rung 26 is formed, at the level of a central portion 40, by a predetermined section, perpendicular to the extension direction C of the rung 26, for example of rectangular shape.

To improve the mechanical resistance of the attachment between the rungs 26 and the beams 22, the rungs 26 and the beams 22 are arranged such that the surface area of the fixing surface of the rung 26 is greater than the surface area of the predetermined section at the level of the central portion 40. The surface area of the predetermined section is defined by the area delimited by the outer envelope of the predetermined section. Increase in the contact surface between the rungs 26 and the beams 22 allows greater efficacy of adhesion and better distribution of forces between the rungs 26 and the beams 22. Also, the improvement in mechanical resistance of each of the attachments between the rungs 26 and the beams 22 allows improvement of the overall mechanical resistance of the fourth section 18₄ and therefore of the ladder 10.

This increase of the surface area of the fixing surface is obtained especially by the fact that the rungs 26 have ends of flared shape. The effect of this is to increase the distance separating the extension direction C of the rung 26 from the outer edge of the rung 26 such that the mechanical resistance of the rung 26 is improved, especially in the face of flexion of the rung 26. Any other form for increasing the distance separating the extension direction C of the rung 26 from the outer edge of the rung 26 can match the ends of the rungs 26. Also, the fixing surface can be composed of one or more surfaces. In other terms, the fixing surface can be continuous or discontinuous.

To further improve the mechanical resistance of the attachment between the rungs 26 and the beams 22, especially in the event of torsion of the fourth section 18₄ around its principal axis of extension, the lateral surface 42 of the beams 22 is inclined relative to a plane perpendicular to the extension direction C of the rungs 26. In particular, the lateral surface 42 is inclined at an angle between 5° and 50° relative to the plane perpendicular to the extension direction C of a rung 26. This angle of inclination of the lateral surface 42 also corresponds to the angle formed between the fixing surface of the rung 26 and the plane perpendicular to the extension direction C of the rung 26.

Also, the combination of the flared form of the ends of the rungs 26 and of the inclination of the lateral surfaces 42 allows the fourth section 18₄ to do without addition of reinforcement pieces—called braces—arranged between the rungs 26 to ensure the physical integrity of known telescopic ladders, especially in the event of forces exerted by cross-winds on the ladder 10. For constant spacing between the two beams 22 and a constant length of the surface on which the user is supported, the inclination of the lateral surfaces 42 also increases the size of the section of the beams 22 such that the beams 22 have increased mechanical resistance.

In reference again to FIG. 2, the fourth section 18₄ also comprises two handrails 28 each extending along one of the two beams 22, substantially parallel to the beams 22. A plurality of support arms 30—also called diagonal—is fixed between one of the beams 22 and the handrail 28 extending along this beam 22. The support arms 30 are arranged inclined relative to the extension direction of the beams 22 and the handrails 28.

To simplify the design of the support arms 30 and their attachment to the beams 22, each support arm 30 is formed jointly with another support arm 30 integrally to form a handrail support 32 substantially having a V form. The handrail supports 32 are arranged end to end between a beam 22 and the handrail 28 extending along this beam 22 such that the elbow of the V of a handrail support 32 is fixed to the beam 22 and the free ends of the V are fixed to the handrail 28.

In reference to FIG. 4, each handrail support 32 comprises a base 34 for fixing the handrail support 32 to an upper surface 23 of a beam 22. The base 34 comprises an inclined portion 36 extending beyond the upper surface 23 of the beam 22 to allow the base 34 to be also fixed on the lateral surface 42 of the beam 22. The inclined portion 36 allows an increase of the contact surface between the handrail support 32 and the beam 22 such that the distribution of forces and therefore the mechanical resistance of the attachment between the handrail support 32 and the beam 22 are improved.

To improve the mechanical resistance both of the attachment between a rung 26 and a beam 22 and of the attachment between a handrail support 32 and a beam 22, when the base 34 of the handrail support 32 is put in contact with the upper surface 23 of a beam 22 and when a rung 26 is arranged on the lateral surface 42 of the same beam 22 facing the handrail support 32, the inclined portion 36 of the handrail support 32 is capable of covering the fixing portion 38 of the rung 26. In other terms, the inclined portion 36 is capable of overlapping the fixing portion 38 of the rung to allow the joining of the inclined portion 36, the fixing portion 38 and the lateral surface of the beam. The inclined portion 36, the fixing portion 38 and the lateral surface 42 of the beam 22 can be riveted together to reinforce the attachment between the handrail support 32, the rung 26 and the beam 22.

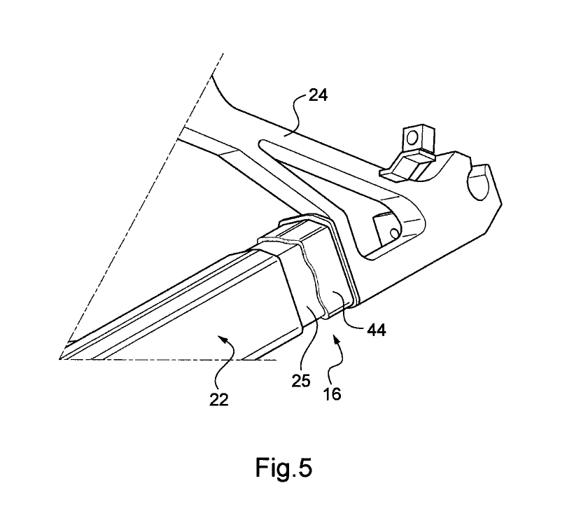

In reference to FIG. 5, the fourth section 18₄ also comprises at the level of the distal end 16 an interface piece 24 for fixing a suspended nacelle (not shown) to the ladder 10. In particular, the interface piece 24 is intended to be fixed, at one end, to the ladder 10 and, at another end, to an inclination device (not shown) on which the nacelle is mounted. The inclination device inclines the nacelle relative to the ladder 10 so as to retain the horizontal aspect of the nacelle relative to the ground. The interface piece 24 is fixed at the level of the distal end 16 of the ladder 10 by sleeving, that is, the pieces are threaded inside each other. In particular, each beam 22 comprises at the level of an end intended to be fixed to the interface piece 24 a portion of reduced section 25 such that a hollow portion 44 (shown in partial section) of the interface piece 24 complementing the form of the portion of reduced section 25 of the beam 22 can be housed and adjust to the portion of reduced section 25. The handrail 28 is fixed by sleeving with the interface piece 24, similarly to attachment between the beams 22 and the interface piece 24. Attachment by sleeving allows for better distribution of forces between the two pieces fixed such that the attachment resists greater stresses than an attachment where the two pieces are assembled end to end.

Also, it is clear from the fact a section 18 is made completely of material that at least the beams 22, the handrails 28, the rungs 26 and the handrail supports 32 are made of this same material. In other terms, the expression “made completely” does not exclude that the section comprises other pieces such as assembly or attachment pieces, made of another material, for example of greater density. Also, it is clear from the fact a section 18 is made partly from material that at least one, but not all, of the beams 22, the handrails 28, the rungs 26 and the handrail supports 32 is made of this same material.

Of course, the present invention is not limited to the examples and embodiment described and illustrated, but it can take the form of many variants accessible to those skilled in the art. By way of example, attachment by sleeving between the interface piece 24 and the beams 22 can be reversed, that is, the interface piece 24 comprises a portion whereof the section is reduced and the beams 22 comprise a hollow portion complementing the form of the portion of reduced section of the interface piece 24 such that the portion of reduced section can be housed and adjust inside the hollow portion. This attachment by reverse sleeving is also applicable to attachment between the interface piece 24 and the handrails 28. Also, in addition to the section arranged at the level of the distal end 16—the fourth section 18₄, the section 18 which precedes it—the third section 18₃—can also be made of material based on carbon fibre to enable greater reduction of the mass of the ladder 10 and to get closer to the centre of gravity of the ladder 10 of the proximal end 12.

What is claimed is:

1. A telescopic ladder comprising a proximal end adapted to be fixed on a support, the ladder comprising between the proximal end and a distal end a plurality of sections displaceable relative to each other for deploying the ladder, the section arranged at the level of the proximal end of the ladder being made of material having a density greater than the density of the material of which at least one other section of the ladder is made.

2. The ladder according to claim 1, wherein the at least one other section than the section arranged at the level of the proximal end is made, fully or partly, of material whereof the density is less than 5.

3. The ladder according to claim 1, wherein the at least one other section than the section arranged at the level of the proximal end is made, fully or partly, of material comprising carbon fibres.

4. The ladder according to claim 1, wherein the at least one other section than the section arranged at the level of the proximal end comprises:
two beams; and
at least one rung capable of being fixed between the beams, the rung extending in an extension direction and having at the level of a central portion of the rung a predetermined section perpendicular to the extension direction, the rung comprising a fixing surface of the rung to one of the beams, the surface area of the fixing surface being greater than the surface area of the predetermined section.

5. The ladder according to claim 4, wherein the beams each comprise a lateral surface capable of receiving the fixing surface of the rung, the lateral surface of at least one beam being inclined relative to a plane perpendicular to the extension direction of the rung.

6. The ladder according to claim 5, wherein the at least one other section than the section arranged at the level of the proximal end comprises a plurality of rungs adapted to being fixed and extending between the beams each following an extension direction, wherein the lateral fixing surface of at least one beam is inclined relative to a plane perpendicular to the extension direction of each of the rungs.

7. The ladder according to claim 4, wherein the two beams of the section comprise a lateral surface inclined relative to a plane perpendicular to the extension direction of at least one rung, preferably of each of the rungs.

8. The ladder according to claim 4, wherein at least one rung comprises an end of flared shape.

9. The ladder according to claim 4, wherein the at least one other section than the section arranged at the level of the proximal end also comprises:
two handrails each extending along one of the two beams; and
a plurality of support arms of the handrails adapted to being fixed between a beam and a handrail extending along this beam;
wherein each support arm is formed jointly with another support arms integrally.

10. The ladder according to claim 9, wherein two support arms formed jointly integrally form a handrail support comprising a base adapted to being put in contact and fixed on an upper surface of a beam, the base comprising an inclined portion operably extending beyond the upper surface of the beam to allow the base to also be fixed on the lateral surface of this beam.

11. The ladder according to claim 10, wherein the inclined portion of the handrail support is capable, when the base of the handrail support is put in contact with the upper surface of a beam and when a rung is arranged on the lateral surface of the beam facing the handrail support, of covering a fixing portion of the rung.

12. The ladder according to claim 11, wherein the inclined portion, the fixing portion of the rung covered by the inclined portion and the lateral surface of the beam are fixed together.

13. The ladder according to claim 4, wherein at least one of the rungs and, where needed, the handrail support are fixed together or to the beam by at least one of: adhesion and riveting.

14. The ladder according to claim 4, wherein the distal end of the ladder is defined when the ladder is fully deployed, the at least one other section than the section arranged at the level of the proximal end being that of the sections arranged at the level of the distal end of the ladder.

15. The ladder according to claim 1, which is a ladder for a fire protection vehicle and/or personal rescue vehicle, the proximal end of the ladder being adapted for coupling to the vehicle and the distal end being capable of being fixed to a suspended nacelle.

16. A telescopic ladder apparatus comprising:
a telescopic ladder comprising a proximal end coupled to a support, a plurality of sections between the proximal end and a distal end movable relative to each other for deploying the ladder, the section located at the level of the proximal end of the ladder being a material having a density greater than a density of material of at least one other section of the ladder; and
a vehicle comprising one of: a fire protection vehicle or a personal rescue vehicle, and the telescopic ladder being coupled to the vehicle.
